(19) United States
(12) Patent Application Publication
(10) Pub. No.: US 2003/0022389 A1
(43) Pub. Date: Jan. 30, 2003

(54) Chemical specific adsorption aerogel for sample collection

(75) Inventors: Fred S. Miller, Bethel Island, CA (US); Brian D. Andresen, Livermore, CA (US)

Correspondence Address: Alan H. Thompson, Assistant Laboratory Counsel, Lawrence Livermore National Laboratory, P.O. Box 808, L-703, Livermore, CA, 94551, US

(73) Assignee: The Regents of the University of California

(21) Appl. No.: 09/919,173

(22) Filed: Jul. 30, 2001

(51) Int. Cl. G01N 1/00

(52) U.S. Cl. 436/174; 422/99

(57) ABSTRACT

The use of treated and/or impregnated aerogels, for chemical specific adsorption, as a sample collection media. The chemically specific aerogel provides an adsorbate as a sampling medium for airborne applications such as stack emissions, clean room environments, personnel dosimetry, etc. The aerogel is treated and/or impregnated to adsorb specific chemistries. The aerogel, after adsorption of a specific chemistry may be heated to release the collected species, or may be dissolved to release the collected species, whereafter the collected species may be analyzed in a GC/MS. The aerogels may be used in the both low and high-volume collectors. This process allows quicker, and therefore cheaper, analysis of airborne substances.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

The present invention relates to the collection of airborne substances, particularly to the use of aerogels as a substance collection media, and more particularly to the production and use of aerogels treated and/impregnated for chemical specific absorption, as a low or high volume sample collection media.

In recent years, extensive efforts have been directing to the collection and analysis of airborne substances, particularly in fields involving chemical weapons, clandestine drugs, terrorist explosives, and non-proliferation surveillance of nuclear weapons manufacturing, as well as for EPA stack emissions monitoring, personnel dosimetry, environment monitoring, clean room monitoring, etc. Various materials have been proposed for sample collection, as well as different processes and apparatus having been developed to accomplish the various monitoring tasks.

The present invention provides treated and/or impregnated aerogels as an environmental and industrial sampling medium for airborne target compounds. The invention provides a solution to the need in the field of sample collection high volume samplers and low-flow sampling devices for personnel and area monitoring. Thus, a sample collection medium has been designed using aerogels to absorb specific pollutant gases, by alternation of the sol-gel chemistry and processing techniques used to make aerogels.

As known, an aerogel is a type of open-cell foam, prepared by sol-gel reactions and processed by drying the gel under supercritical conditions to avoid collapse of the cell structure due to surface tension. The basic synthetic approach to create aerogel catalysts is the co-hydrolysis and condensation of a metal alkoxide with the matrix alkoxide. The resulting mixed metal oxide-matrix gel is then dried by critical point extraction, which results in an aerogel. The microstructure of the aerogel resembles a three-dimensional network of interconnected beads of 10-100 Å in size, with pore diameters formed by the bead structure of 50 to 500 Å.

The present invention involves aerogel chemistry sol-gel production to include the incorporation of carefully selected adsorption chemicals that will be used to target specific gases or vapors of interest, followed by crushing the produced aerogel and placing the crushed aerogel in a collection chamber, such as a glass collector, and then expose the collector to toxic gas. After exposure, the aerogel material can be heated or dissolved to release the collected sample, which can be then analyzed in a GC/MS.

### SUMMARY OF THE INVENTION

It is an object of the present invention to provide chemically specific airborne collection.

A further objective of the invention is to provide for airborne sample collection utilizing an aerogel material.

Another object of the invention is to provide a treated and/or impregnated aerogel as a sampling media for airborne target compounds.

Another object of the invention is to provide an aerogel with a chemically specific adsorbing chemistry for use as a sampling medium for airborne gases or vapors.

Another object of the invention is to provide a sample collection media which can be designed for either high or low flow volumes.

Another object of the invention is to provide an aerogel airborne collection media which can release the collected sample by either heating or dissolving the aerogel media.

Other objects and advantages of the present invention will become apparent from the following description and accompanying drawings. Basically, the invention involves a sample collection media composed of treated and/or impregnated aerogels. The aerogel collection media can be produced to adsorb specific pollutant gases or vapors by alteration of the sol-gel chemistry and processing techniques used to produce aerogels. The invention basically involves producing an aerogel having a desired chemically specific adsorbing composition, crushing the thus produced aerogel and containing it in a sample collector, exposing the crushed aerogel to an environment for collecting a sample, and thereafter heating the aerogel to release the sample or dissolving the aerogel in a liquid solvent, like ultra pure water, and analysing the collected sample in a GC/MS. The invention was experimentally verified using nonproliferation inspection airborne compounds and chemical warfare (CW) airborne compounds of interest. The invention involved the selection of aerogel chemistries and determination as to what metals or materials would alter the aerogel chemistry so as to produce a desired chemically specific adsorbing aerogel. Since the aerogels can be dissolved in water, filtered, and analyzed in a GC/MS, the process allows for quicker analysis, and therefore less expensive, than processing activated charcoal and other related collection approaches.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 illustrates an embodiment of a low volume sampler wherein a selected and crushed reactive aerogel adsorbate is contained in an impinger or glass casing.

FIG. 2 illustrates an embodiment of a high volume sampler wherein a selected and crushed reactive aerogel adsorbate is compressed into a ring or cylinder.

FIG. 3 illustrates processing of the aerogel following sample collection, wherein the aerogel is dissolved and the sample is thereafter analyzed in a GC/MS.

### DETAILED DESCRIPTION OF THE INVENTION

The present invention involves aerogel samples designed with the ability to adsorb a specific gas or vapor or to adsorb a range of pollutant gases by altering the sol-gel chemistry and processing techniques. For example, if glass fibers were placed in the sample collector (glass fibers with a diameter range of 0.2-1.0 μm in crushed or particulate aerogel, treated or untreated) particles of toxic compounds can also be collected. The aerogel samplers can be in the shape or impingers (low volume), respirators or AHEPA filters for high volume sampling. The aerogel can be tailor-made to contain specific cation, or anion, or lipophilic species which traps specific suits of compounds of importance. Once the samples have been collected, the aerogel sampler can be placed in water or other liquid, the aerogel dissolved, the water (liquid) filtered, and the sample analyzed in a GC/MS. Also, the aerogel can be heated to release the collected sample, whereafter the ample is analyzed. Passive adsorption colorimetric response to airborne compounds can be used to visually monitor exposure to specific airborne compounds. Dynamically exposed to discrete airborne concentrations of specific target compounds, the aerogel samples collector or filters can be visually monitored for break through. Spent material is of a different color than unused collection or filtration medium.

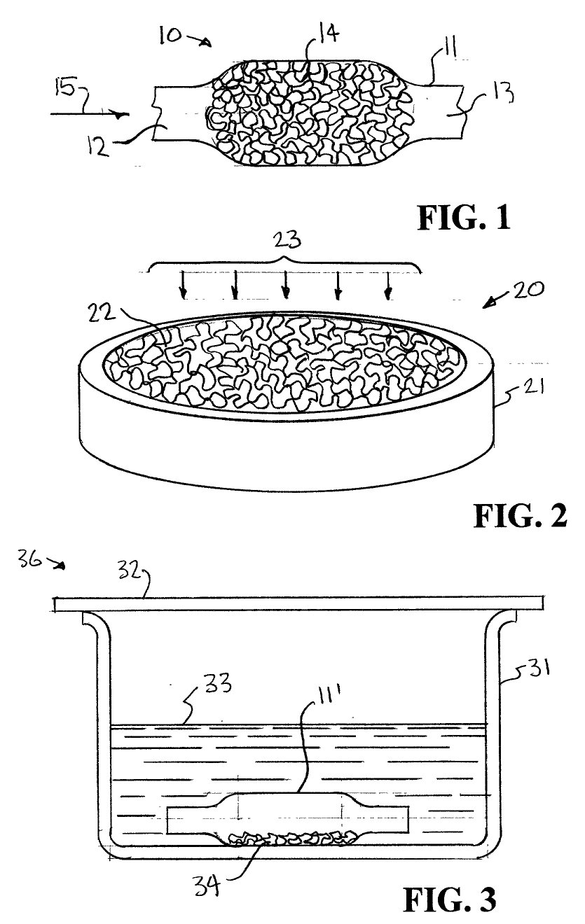

Referring now to the drawings, FIG. 1 illustrates an embodiment of a low volume sampler, generally indicated at 10 and includes an impinger, such as a glass casing, 11 having open ends 12 and 13, and within which is contained a crushed reactive aerogel adsorbate 14. Air flow, indicated by arrow 15 passes through the impinger 11 via the openings 12 and 13 and selected airborne pollutants or target compounds are adsorbed by the aerogel adsorbate 14.

FIG. 2 illustrates a high volume sampler generally indicated at 20 and includes a hollow sleeve, casing, or cylindrical member 21, constructed of material such as glass, and in which is packed a crushed aerogel absorbate 22 which contains glass fibers (1-0.2 μm), and which may be untreated or treated with unique chemicals that trap target compounds, as air flow indicated by arrows 23 pass through the adsorbate 22.

The samplers of FIGS. 1 and 2 act like a spider web to catch unique target compounds.

As pointed out above, once the target compounds (samples) have been collected by the samplers of FIGS. 1 or 2, the sampler is placed in water or other liquid, the aerogel adsorbate dissolved, the water filtered out, and the aerogel residue containing the target compound analyzed in a GC/MS. FIG. 3 illustrates a simple apparatus used to obtain the target compound collected by an impinger as illustrated in FIG. 1. As shown, the apparatus generally indicated at 30 comprises a container or beaker 31 having a cover 32 and containing a quantify of liquid 33 such as water of a volume sufficient to cover an impinger 11′ placed therein. The aerogel adsorbate contained in the impinger 11′ is dissolved by the water leaving an aerogel residue 34. After aerogel adsorbate is dissolved, the impinger is removed, and the water is filtered and extracted, leaving the aerogel residue containing the target compound or compounds which is thereof analyzed in a GC/MS.

Also, the aerogel adsorbate, following collection of target compounds, can be heated to temperature below its melting point to purge the collected compounds, which are trapped for GC-MS analysis.

The overall experimental process for carrying out verification the invention included the following operations:

1. Design aerogel chemistry sol-gel production to include the incorporation of carefully selected adsorption chemicals that will be used to target specific gases of interest.

2. After the supercritical extraction, the aerogel is crushed, then compressed and placed into experimental chambers, such as glass containers or collectors for systematic exposure to various concentrations of airborne toxic compounds and particulate.

3. Connect the sample collector to a vacuum line to draw external air over the collection medium, and expose the collector to a gaseous compound or vapor above a liquid compound of interest by placing the collector near the top of a container containing the compound of interest.

4. Pass precise concentrations of airborne toxic gas over specifically selective aerogel chemistries to analyze the collection efficiency.

5. The sample and collector is then dissolved in a liquid solvent, like ultra water and analyzed in a GS-MS.

Various types of aerogels were produced and tested during the experimental verification of the invention. The aerogels were primarily silica aerogels with various additives. Also, while numerous gases were considered including iodine vapor, dodecane, nitro benzene, and kerosene, dodecane was selected as collection via hydrogen bonding seemed to be a reasonable starting point. Dodecane has an extremely low vapor pressure, and would be difficult to collect, compared to compounds that are quite volatile. Also, various metals were considered for use to alter the sol-gel process. The aerogels were made with a range of densities. For example, silica aerogel can be made with a density as low as 0.003 g/cm³ (on the same order of density as air), up to full density glass of 2.2 g/cm³. The metal oxide-silica aerogels have typically been made with densities of 0.22 g/cm³, while the pure metal oxide aerogels, such as tantala, have been made from 0.1 to 0.7 g/cm³. The experimental tests involved the use of a series of metal doped and metal oxide aerogels for the purpose of adsorbing specific airborne or families of airborne compounds, and the average surface area of the aerogels was about 300∩1000 m²/g, depending on the composition.

The following sets forth experimental results carried out during verification of the present invention.

Silver aerogel: The initial result was impressive. We verified proof of principle: aerogel could passively adsorb a vapor. We placed a piece of aerogel in a sealed container that had iodine vapor in it. The gray aerogel turned orange. This was an indication that the aerogel formed silver iodide, which is orange. When the piece of aerogel was removed from the container it returned to the original color, which was light gray. This indicated that the reaction could be reversible. As far as we could see, it was reversible. We placed the piece of aerogel back in the container and it turned orange again.

Building on this result we decided to formulate silver with other transition metals in the aerogel matrix. This was a slight deviation from specific selectivity, but it was pertinent to sample collection. After formulating a number of silver/transition metal compounds, we conducted more tests.

Silver fluoride aerogel turned from brown to orange when exposed to some of the chloro compounds that had been initially selected. Building on these results we made silver aerogel in combination with other metals and screened the materials for further colormetric reactions.

We found that silver/copper aerogel turned brown when exposed to Diethyl chlorothiophosphate, and turned yellow when exposed to Ethyl dichlorophosphate.

Silver/nickel aerogel changed color when exposed to a series of airborne compounds. It changed from blue to green. However, when it was exposed to the airborne compounds separately, the color change did not occur. Since it was possible that a complex gas metal reaction had taken place with the silver/nickel aerogel, we tested it against each gas separately. There was no color change when the aerogel was exposed to the gaseous vapors individually. The silver/nickel aerogel probably reacted with a particular gas in the series and then that complex reacted with another gas to promote the color change.

We designed an experiment that involved the Cu/Ag, Ni, and V Aerogel. We exposed the aerogel to the following: 2,2′-Thiodiethanol, Diisopropylmethyl phosphate, Diethyl chlorophosphate, 2(dissopropyl)Amino Ethanol, Trimethyl phosphate, Dimethyl methylphosphonate, Ethyl dichlorohosphonante. In that order. The Cooper/Silver Aerogel turned from brown to black when it was exposed to diethyl chlorophosphate, and turned yellow-orange when it was exposed to ethyl dichlorophosphonate. This was not part of the colormetric screening, but was an observed reaction. Upon GC/MS analysis the Vanadium Aerogel showed trace Trimethyl Phosphate, Alkyl Phosphate, and thiophosphate peaks. After this experiment we designed a number of varied aerogel chemistries, and decided to expose the different chemistries to a variety of gaseous compounds. All materials were analyzed on the GC/MS.

Copper Metal Aerogel: Exposed to Dodecane and Tributyl Phosphate. This aerogel adsorbed dodecane. There was no colormetric reactions observed.

Cobalt (III) Aerogel: Exposed to Dodecane and Tributyl Phosphate. Detected dodecane.

Vanadium Phthalocyanine Aerogel: Exposed to 2,2′-Thiodiethanol, Diisopropylmethyl phosphate, Diethyl chlorophosphate, 2(diisopropyl)Amino Ethanol, Trimethyl phosphate, Dimethyl methylphosphonate, Ethyl dischlorophosphonate. Detected trace Trimethyl Phosphate, Detected Alkyl Phosphate, and Thio phosphonate. Exposed the aerogel to Diethyl Methane Phosphate, Nitrobenzene, and Triethylamine. Detected Diethyl methane phosphonate, and trace nitrobenzene.

Platinum IV Aerogel: Exposed to Dodecane, Tributyl Phosphate, and Kerosene. Excellent dodecane peak, detected tributyl phosphate.

Nickel Nitrate Aerogel: Exposed to 2,2′-Thiodiethanol, Diisopropylmethyl phosphate, Diethyl chlorophosphate, 2(diisopropyl)Amino Ethanol, Trimethyl phosphate, Dimethyl methylphosphonate, Ethyl dichlorophosphonate. When exposed in sequence there is a color change from light green to a brilliant blue color. Setected Trimethyl Phosphate, Alkyl Phosphonate, and Thio Phosphate. Exposed to Dodecane and Tributyl Phosphate. Detected Dodecane.

Cobaltous Sulfate/Silver Nitrate Aerogel: Exposed to Iodine vapor material changed from blue to orange.

Tungsten/Zinc Aerogel: Exposed to Dodecane and Tributyl Phosphate. Did not change color, and did not detect either compound.

We made aerogel with Ninhydrin, and Cobalt (II) Thiocyanate: We exposed the resulting aerogel to cocaine and other drug compounds with no response. The Ninhydrin is soluble in liquid CO₂, so it was not present in sufficient quantities to react. The cobalt compound was altered during processing.

Platinum IV/Platinum II Aerogel: Exposed to Dodecane, Tributyl Phosphate, and Kerosene. Exposed to Dodecane, Tributyl Phosphate, and Kerosene. Detected Dodecane trace Tributyl Phosphate.

Niobium/Barium Aerogel: Exposed to Dodecane, Tributyl Phosphate, and Kerosene. Detected small Dodecane.

Silver Nitrate/Cupric Nitrate Aerogel: Exposed to 2,2′-Thiodiethanol, Diisopropylmethyl Phosphate, Diethyl chlorophosphate, 2(diisopropyl)Amino Ethanol, Trimethyl phosphate, Dimethyl methylphosphonate, Ethyl dichlorphosphonate. Detected Trimethyl Phosphate, Butyl Trimethyl Phosphate, Boric Acid, and Alkyl Phosphate. Exposed to Dodecane and Tributyl Phosphate. Dectected Dodecane and trace amounts of Tributyl Phosphate.

Manganese (III) Acetylcaetonate/Vanadium Phthalocyanine: Exposed to Dodecane and Tributyl Phosphate. Detected Dodecane and trace amounts of Tributyl Phosphate.

Niobium/Nickel/Cadmium Aerogel: Exposed to Dodecane and Tributyl Phosphate. Detected Dodecane.

Silver/Copper Aerogel: Turned brown when exposed to Diethyl Chlorothiophosphate. Turned yellow when exposed to Ethyl Dichlorophosphate.

Silver Fluoride Aerogel: Turned orange when exposed to Ethyl Dichlorophosphate, and turned orange when exposed to Diethyl Chlorothiophosphate. There was no detection of Dodecane or Tributyl phosphate.

Ferric Nitrate Aerogel: Did not detect Tributyl Phosphate or Dodecane.

Praseodymium Nitrate/Chromic Oxide Aerogel: Exposed to Dodecane and Tributyl Phosphate. Detected Dodecane.

Ceric Ammonium Nitrate/Nickel Nitrate: Exposed to Dodecane and Tributyl Phosphate. Detected Dodecane.

Silver Nitrate Aerogel: Turned bright orange when exposed to iodine vapor. Detected trace Tributyl Phosphate when exposed to Dodecane and Tributyl Phosphate. Detected trace Tributyl Phosphate.

Nickel Nitrate/Niobium Aerogel: Exposed to Dodecane and Tributyl Phosphate. Detected trace Tributyl Phosphate.

Iron Aerogel: Exposed to Dodecane and Tributyl Phosphate. Detected Dodecane.

Copper Aerogel: Exposed to Dodecane and Tributyl Phosphate. Detected Dodecane.

Sodium Palladium Aerogel: Exposed to Dodecane and Tributyl Phosphate. Detected Dodecane.

At this point it was decided to design the most extreme test of an adsorbate, and test the aerogel against activated charcoal. We selected and tested the materials that had performed at the best level for adsorbing Dodecane. We selected the Platinum IV Aerogel, as the best performed Dodecane adsorbate. Even though the intensity levels of the GC/MS were qualitative, since the test conditions were the same, the difference of the peak intensity was used as a quality indicator. The more compound adsorbed, the more intensity yielded. We placed a small amount of Dodecane in the bottom of an eight inch bottle, just enough to wet the bottom of the bottle. Then we put equal volumes of Activated Charcoal and Platinum IV Aerogel in sample collectors. The collectors were placed at the top of the bottle for set time periods. The intensity of the peaks on the GC/MS were equal in magnitude, and close in counts. They both had good to excellent intensities 30,000 to 300,000 depending on time of exposure. Intensity levels went up as did time of exposure. Interestingly enough, the Aerogel collector went up proportionally to the time of exposure.

The tests were repeated, with the same results.

Then we placed a small amount of dodecane in the bottom of a desiccator. We placed a ceramic shelf about two inches above the Dodecane container. We placed a series of Aerogel Chemistries in 5 ml beakers, and one beaker that contained Activated Charcoal on the ceramic shelf. The container was sealed and the temperature was varied. The materials were weighed on an extremely sensitive scale. We were surprised to find that the Platinum IV Aerogel seemed to out perform the Activated Charcoal at room temperature and the temperature one might expect to find in the desert. To determine a weight adsorbed percentage we divided the weight increase by the weight of the material, so the comparison would be as accurate as possible. At room temperature, 25° C.: Platinum IV—7.592%, Activated Charcoal—6.058%, Chrome/Moly Aerogel—2.548%, Pt II/Pt IV/Mg Aerogel—1.626%, Pt IV/Palladium Aerogel—5.096%, Copper/Silver—7.858%, Palladium Aerogel—8.628%. Therefore, it is our opinion that we can design Aerogel materials that adsorb better than Activated Charcoal, and materials that can adsorb specific compounds of interest, which Activated Charcoal is unable to do.

As the temperature went up, the results were even more interesting. Every adsorbate decreased in weight, except one. In fact, the materials weighed less at 50° C. than they did at the beginning of the experiment. Desert conditions are approximately 50° C., and a sample collector should continue to collect at temperatures other than lab conditions. Even though every adsorbate, including Activated Charcoal, was less than it was at the beginning of the experiment, the Platinum IV Aerogel increased in weight, and showed an increase in adsorbed material. The weight of adsorbed compound more than doubled. This indicated that at desert conditions, it is quite likely that an Activated Charcoal will desorb any collected compounds, yielding false data. The Platinum IV Aerogel adsorbed more compound at desert conditions and its weight percentage was 15.556%. All other adsorbates had desorbed to less than their starting weight. At 100° C. Platinum IV Aerogel began to outgas and the adsorbed weight percentage dropped to 7.373%. All other adsorbate were far less than their starting weights. At 150° C. the Platinum IV Aerogel lost all adsorbed material. Indications are strong that we have developed a more efficient sample collection medium that is superior to other collection media and one that has the capability to specifically adsorb airborne compounds. Proof of Principle has been verified.

It has thus been shown that the present invention enables the use of treated and/or impregnated aerogels as an environmental and industrial sampling media for airborne target compounds. The invention enables the development of chemically specific adsorbing chemistries for aerogel for use as an adsorbate for numerous target compounds. The aerogel, after collecting airborne target compounds, can be dissolved in a solution or heated to a temperature below the melting point to release the collected sample for analysis. The invention has numerous applications including EPA stack monitoring, personnel dosimetry, environmental monitoring, area monitoring, chemical weapons convention, clandestine drugs/laboratories, terrorist explosives, non-proliferation or surveillance of nuclear weapons manufacturing, and clean room monitoring.

While particular embodiments, materials, parameters, etc. have been illustrated and/or described to exemplify and teach the principles of the invention, such are not intended to be limiting. Modifications and changes may become apparent to those skilled in the art, and it is intended that the invention be limited only by the scope of the appended claims.

The invention claimed is

1. In a device for collecting airborne target samples for analysis, the improvement comprising:
a quantity of crushed reactive aerogel adsorbate.

2. The improvement of claim 1, wherein said aerogel adsorbate includes chemically specific adsorbing chemistries for adsorbing specific target compounds.

3. The improvement of claim 1, wherein said aerogel adsorbate includes glass fibers.

4. The improvement of claim 3, wherein said glass fibers are of a 1-0.2 μm size.

5. The improvement of claim 1, wherein said aerogel adsorbate is impregnated with a metal.

6. The improvement of claim 1, wherein said aerogel adsorbate has a surface area ranging from about 300 m²/g to about 1100 m²/g.

7. The improvement of claim 1, wherein said aerogel adsorbate has a density in the range of about 0.003 g/cm³ to about 0.7 g/cm³.

8. The improvement of claim 1, wherein said aerogel adsorbate is composed of crushed aerogel selected from the group consisting of chemically treated silica aerogels, untreated inorganic aerogels, metal impregnated silica aerogels, metal oxide-silica aerogels, and pure metal oxide aerogels.

9. The improvement of claim 1, wherein said crushed reactive aerogel adsorbate is contained in an open ended container, whereby airborne target material can flow through the containers for adsorption of target samples by the aerogel adsorbate.

10. The improvement of claim 10, wherein said open ended container is constructed and packed with aerogel adsorbate to form a sampler selected from the group consisting of low volume and high volume samplers.

11. A method for environmental and industrial sampling of airborne target material, comprising providing a quantity of an aerogel absorbate, exposing the aerogel absorbate to an airborne material for collecting a sample thereof, removing the collected sample, and analyzing the collected sample.

12. The method of claim 12, additionally including forming the aerogel absorbate so as to contain chemically specific adsorbing chemistries.

13. The method of claim 12, additionally including containing the aerogel absorbate in an open ended container prior to exposing the aerogel absorbate to an airborne material.

14. The method of claim 14, wherein containing the aerogel absorbate is carried out so as to form a low volume or a high volume sampler.

15. The method of claim 12, wherein removing the collected sample is carried out by heating the aerogel adsorbate to a temperature below the melting point of the aerogel causing the collected sample to be released, and collecting the released sample.

16. The method of claim 12, wherein removing the collected sample is carried out by dissolving the aerogel adsorbate in a solution, removing the solution, and retaining the collected sample.

17. The method of claim 17, wherein removing the solution is carried out by a filtering operation.

18. The method of claim 12, wherein removing the collected sample is carried out by a method selected from the group consisting of thermal release and liquid dissolving/filtering operations.

19. The method of claim 12, wherein providing the quantity of aerogel absorbate is carried out by selecting an aerogel absorbate from the group consisting of aerogels having chemically specific absorbing chemistries, and aerogels treated or impregnated with material for adsorbing specific target compounds.
